(19) United States
(12) Patent Application Publication
(10) Pub. No.: US 2008/0055089 A1
(43) Pub. Date: Mar. 6, 2008

(54) Adhesive thermo printable label with RFID flap antenna for metallic surfaces

(75) Inventor: Peter Olof Gustafsson, Kallered (SE)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/897,441

(22) Filed: Aug. 30, 2007

Related U.S. Application Data
(60) Provisional application No. 60/841,154, filed on Aug. 30, 2006.

(51) Int. Cl. G08B 13/14

(52) U.S. Cl. 340/572.1

(57) ABSTRACT

A radio-frequency identification (RFID) label carries an embedded RFID antenna and is capable of being affixed to a package or label. The RFID enabled label includes a bottom portion and an RFID flap that includes a first portion attached to the bottom portion and a second portion that carries the RFID antenna. The RFID flap can be placed in a first position in which the second portion carrying the RFID antenna lies adjacent to the bottom portion, such that the RFID enabled label can be used in conjunction with a printer. The RFID flap is put into a second position in which the second portion carrying the RFID antenna is displace from the bottom portion. Displacing the RFID antenna from the bottom portion results in the RFID antenna being displace from the package or surface to which the bottom portion is affixed, allowing the RFID antenna to operate without interference from the package or surface.

### CROSS-REFERENCE TO RELATED APPLICATION(S)

This application claims priority of U.S. provisional patent application Ser. No. 60/841,154 filed on Aug. 30, 2006.

### BACKGROUND

The present invention relates to Radio Frequency Identification (RFID) antennas, and in particular to labels enabled with RFID antennas.

RFID is an automatic identification method that stores and remotely retrieves data using devices known as RFID tags or transponders. Typically, RFID tags contain silicon chips and antennas that enable them to receive and respond to radio-frequency queries from an RFID transceiver. Passive tags require no internal power source, whereas active tags require a power source.

RFID tags are often envisioned as a replacement for Universal Product Code (UPC) or European Article Number (EAN) barcodes, in which RFID tags can be used to quickly and easily track products and inventory. However, high cost and technical difficulties associated with adhering RFID tags to products and packages has limited the wide-spread use of RFID tags. For example, RFID tags affixed to metal surfaces exhibit poor performance.

It would therefore be desirable to produce a label having RFID technology wherein the label may be affixed to any type of packaging or material without adversely affecting the performance of the RFID tag. It would furthermore be beneficial to generate a low cost solution to this problem.

### SUMMARY

Described herein is a radio frequency identification (RFID) enabled label. The RFID label includes a bottom portion and an RFID flap having a first portion adhered to the bottom portion and a second portion. In a first position, both the first portion and the second portion are substantially adjacent to the bottom portion. In a second position, the second portion is displaced from the bottom portion such that an RFID antenna embedded within the second portion is displaced from a packaging or surface to which the RFID enabled label is affixed.

In another aspect, a method of adhering a radio frequency identification (RFID) enabled label to a surface or package is described. The method includes providing the RFID enabled label to a printer in a first position, in which an RFID flap is positioned adjacent a bottom portion of the RFID enabled label. The method further includes applying the RFID enabled label to the surface by adhering the bottom portion of the RFID enabled label to the surface. The RFID enabled label is moved from the first position to a second position, in which the RFID flap is displaced from the bottom portion.

### BRIEF DESCRIPTION OF THE DRAWINGS

FIGS. 1A and 1B are perspective views of an RFID enabled label with an RFID antenna located on an RFID flap.

FIGS. 2A and 2B are cross-sectional views of an embodiment of a RFID enabled label having a shrink-wrap polymer layer that is used to separate the RFID flap from the attached surface during a thermal printing process.

FIGS. 3A and 3B are cross-sectional views of another embodiment of a RFID label having a shrink-wrap polymer layer that is used to separate the RFID flap from the attached surface during a thermal printing process.

FIGS. 4A-4C are perspective views of a RFID label having a tab for mechanically separating the RFID flap from the attached surface.

FIGS. 5A and 5B are cross-sectional views of the RFID label shown in FIGS. 4A and 4B.

FIG. 6 is a perspective view of an alternative embodiment of a RFID label having a tab for mechanically separating the RFID flap from the attached surface.

### DETAILED DESCRIPTION

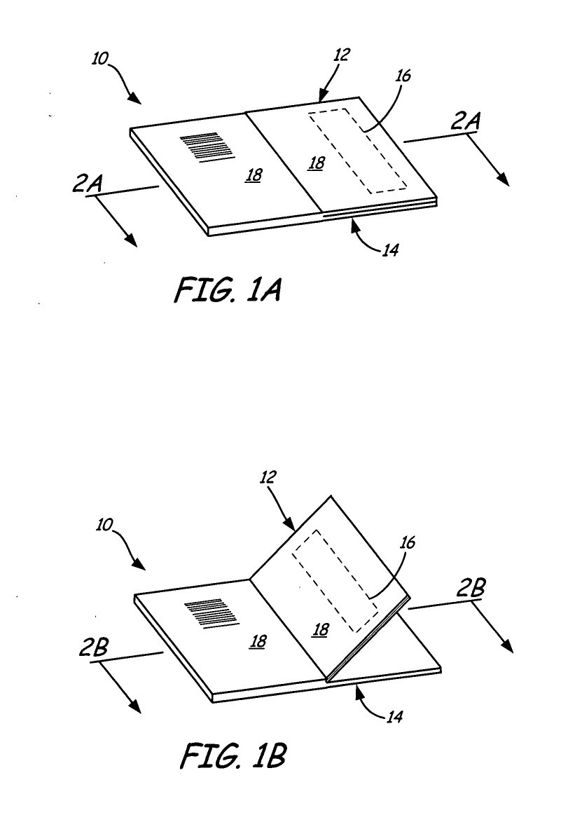

FIG. 1A shows RFID enabled label (“label”) 10 with RFID flap 12 in a first position, in which RFID flap 12 is pressed flat against bottom portion 14 of label 10. FIG. 1B shows label 10 with RFID flap 12 in a second (i.e, operational) position, in which RFID flap 12 is lifted away from bottom portion 14. In this position, RFID chip and antenna 16 (hereinafter, “antenna 16”) is displaced geographically from bottom portion 14. When label 10 is in the first position (i.e., when RFID flap 12 is down), the label may be placed in a typical printer that allows graphics or labels to be printed onto top surface 18. When label 10 is in the second, operational position, bottom portion of label 10 can be affixed to a package or product without the package or product interfering with the read/write capabilities of antenna 16.

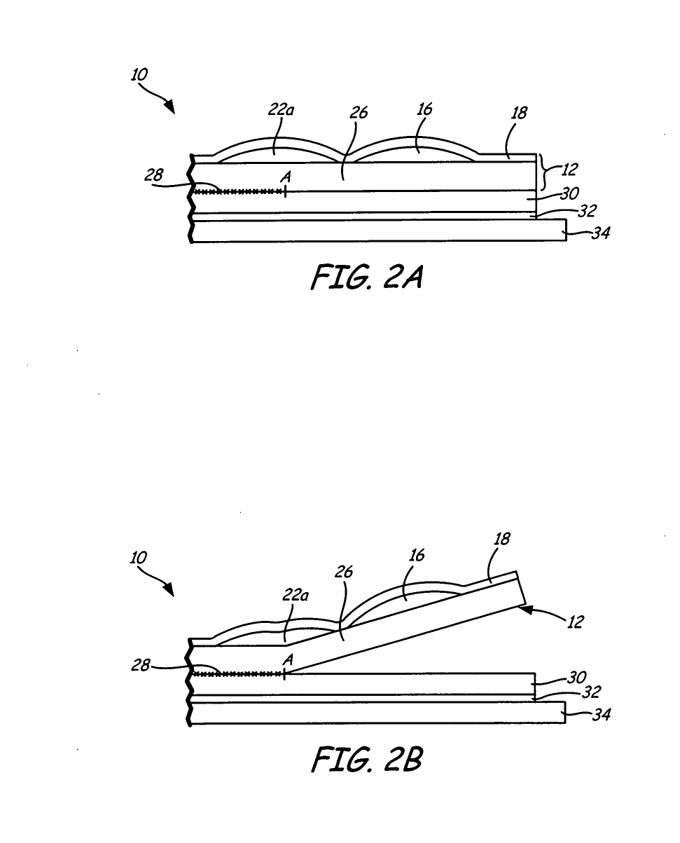

FIGS. 2A-6 illustrate a number of embodiments in which label 10 may be converted from a first, non-operation state (FIG. 1A) to an operational state (FIG. 1B).

FIGS. 2A and 2B are cross-sectional views of an embodiment of an RFID enabled label 10 taken along lines 2A-2A and 2B-2B of FIG. 1, respectively. RFID label 10 includes, but is not limited to, the following: RFID antenna 16, top surface 18, heat activated polymer 22, flap-back face 26, bonding layer 28 (indicated by x marks), carrier layer 30, adhesive layer 32, and backing paper 34.

FIG. 2A shows RFID label 10 in a first, non-operational state in which RFID flap 12 has not yet been separated from the bottom portion of RFID label 10. Top surface 18, heat-activated polymer layer 22a, RFID antenna 16, and flap-back face 26 (to the right of point A) represent the layers that are included in RFID flap 12. A first portion of carrier layer 30 is bonded to a portion of flap-back face 26 by bonding layer 28. A second portion of carrier layer 30 is not bonded to flap-back face 26, which allows RFID flap 12 to be separated from carrier layer 30. Prior to affixing RFID label 10 to a surface, backing layer 34 is removed to expose adhesive layer 32, which is then affixed to the desired surface.

In the embodiment shown in FIG. 2A, images (such as the barcode shown in FIGS. 1A and 1B) are transferred or printed on top surface 18 using, for example, thermal printing techniques. For instance, either direct thermal (DT) or transfer thermal (TT) printing techniques may be employed. Both techniques have the effect of generating a desired image on top surface 20, and both techniques provide a necessary amount of heat to activate heat-activated polymer layer 22a. As shown in this embodiment, heat-activated polymer layer 22 is located over point A, which represents the point where flap-back face 26 is no longer bonded to carrier layer 30 by bonding layer 28. When thermal energy is provided to heat-activated polymer layer 22, it causes the polymer to contract or shrink in size. The contracting of heat-activated polymer layer 22a causes flap back face 26 to pull away from carrier layer 30 in the non-bonded region as shown in FIG. 2B. The result is the separation of RFID flap 12 from carrier layer 30 as shown in FIG. 2B.

As shown in FIG. 2B, following the contraction of heat-activated polymer layer 22a, antenna 16 is physically separated from the bottom portion of label 10. Backing paper 34 is removed to expose adhesive layer 32, allowing label 10 to be affixed to any material without the material interfering with the operation of antenna 16. This is an improvement over prior art methods that required insulation of antenna 16 with plastic packaging to prevent interference. The plastic packaging prevented label 10 from being used in conjunction with a printer. The present invention allows RFID labels to be manufactured such that they are still compatible with commonly used printing techniques.

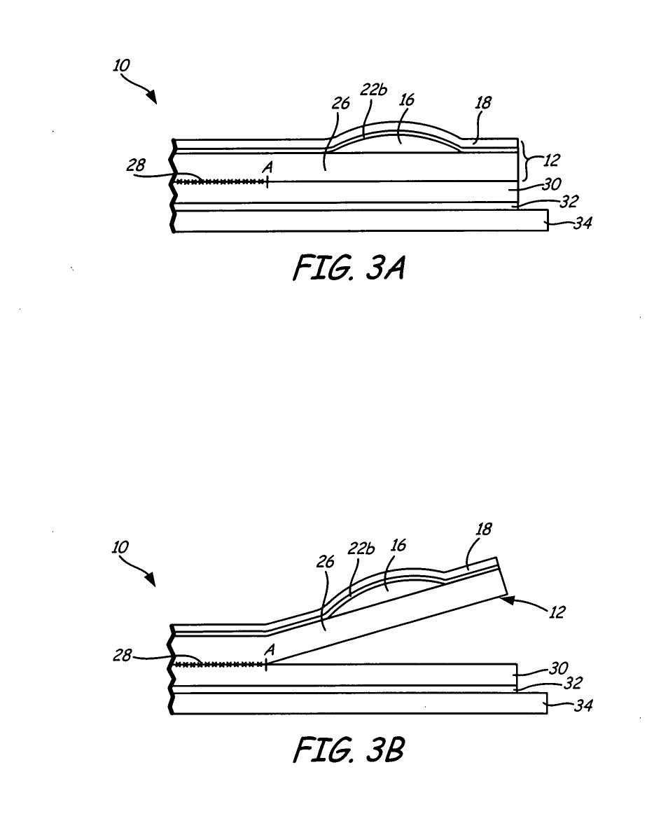

FIGS. 3A and 3B show another embodiment of the present invention, in which a heat-activated polymer layer 22b extends along the length of label 10. This is in contrast with the embodiment of label 10 shown in FIGS. 2A and 2B, in which heat-activated polymer layer 22a was located in a small region located above point A. As shown in FIGS. 3A and 3B, label 10 includes top surface 18, heat-activated polymer layer 22b, RFID antenna 16, flap-back face 26, bonding layer 28 (indicated once again by the x's shown to the left of point A), carrier layer 30, adhesive layer 32, and backing paper 34.

FIG. 3A shows RFID label 10 in a first state in which RFID flap 12 (as shown in FIGS. 1A and 1B) has not yet been separated from the bottom portion of RFID label 36. Thermal energy provided by a thermal printer (or comparable device capable or providing the requisite thermal energy) causes heat-activated polymer layer 22b to contract, resulting in RFID flap 12 being pulled away from carrier layer 30 to the right of point A as shown in FIG. 3B. Therefore, FIG. 3B shows label 10 in a second, operational state in which free space is created between antenna 16 and a material or package to which label 10 is affixed.

In the embodiments shown in FIGS. 2A-2B and 3A-3B, the size of RFID antenna 16 creates a small bump on the surface of RFID label 10. The size of the bump can be minimized as desired by increasing or decreasing the thickness of flap-back face 26, top surface 18, or heat-activated polymer layer 22a or 22b. For example, in one embodiment the size of the bump created by RFID antenna 16 may be minimized by creating a RFID antenna sized slot in flap-back face 26, allowing RFID antenna 16 to be placed in the slot. Similarly, all layers shown in FIGS. 2A-2B and 3A-3B may be adjusted as required to generated the desired geometry of label 10.

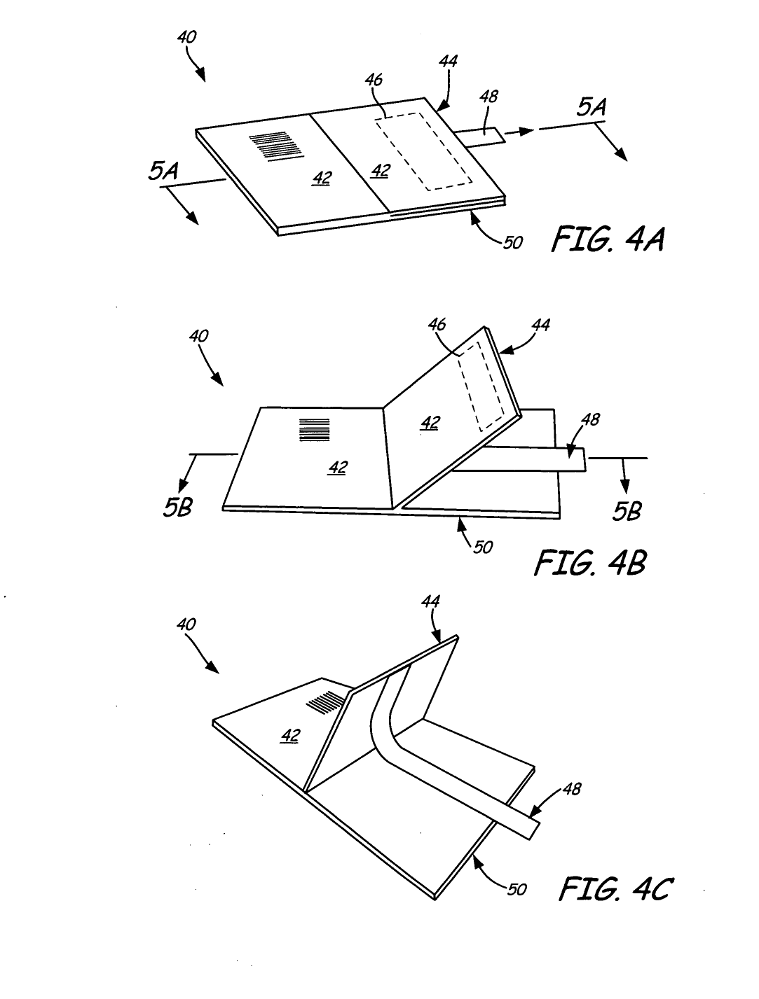

FIGS. 4A-4C are perspective views of another embodiment of the present invention, in which RFID label 40 includes a tab for manually separating an RFID flap from a bottom surface or adhesion layer. In this embodiment, RFID label 40 includes printable surface (or top surface) 42, RFID flap 44 (which houses RFID antenna 46), tab 48, and bottom portion 50. As discussed above, bottom portion 50 includes an adhesive layer that allows RFID label 40 to be affixed to a package or product. Creating space between RFID antenna 46 and the material to which RFID label 40 is affixed allows RFID antenna 46 to operate without interference from the material.

FIG. 4A shows a perspective view of RFID label 40 in a first state, in which RFID flap 44 is pressed against bottom portion 50. In this first state, RFID label 40 may be used in conjunction with a standard printer, allowing images and graphics (such as the barcode shown in FIG. 4A) to be printed onto top surface 42. Following printing (or comparable operations), a user mechanically separates RFID flap 44 from bottom surface 50 by pulling tab 48 in the direction indicated by arrow 51.

FIG. 4B shows a perspective view of RFID label 40 in a second state, in which RFID flap 44 has been mechanically separated from bottom portion 50 by pulling on tab 48. As shown in FIG. 4B, pulling tab 48 creates physical separation between RFID antenna 46 and bottom portion 50. In this state, RFID label 40 may be affixed to a product or package, without the product or package material interfering with RFID antenna 46.

FIG. 4C shows a rotated perspective view of RFID label 40 shown in FIG. 4B, in which RFID label 40 is in the second, operational position. As shown in this view, tab 48 is attached to the upper half of RFID flap 44. This connection style allows tab 48 to be laid flat against bottom surface 50 during printing process (or comparable processes that required label 40 to be flat). Pulling tab 48 in the direction shown by arrow 51 causes RFID flap 44 to be separated from bottom portion 50.

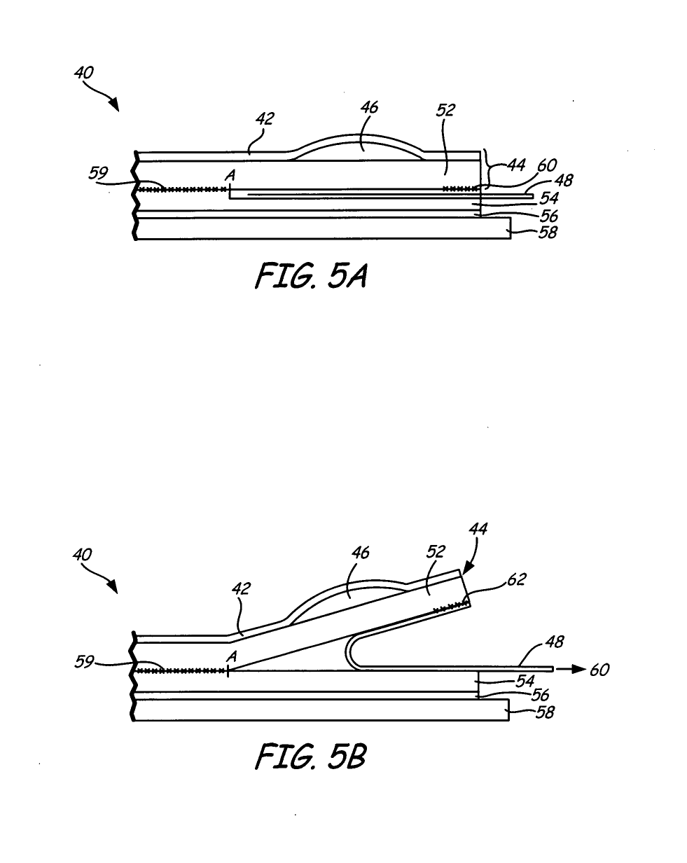

FIGS. 5A and 5B are cross-sectional views of RFID label 40 taken along lines 5A-5A and 5B-5B, respectively. RFID label 40 includes, but is not limited to, the following: printable surface (or top layer) 42, RFID antenna 46, flap-back face 52, tab 48 connected to the top portion of flap-back face 52, carrier layer 54, adhesion layer 56, and backing paper 58. A portion of carrier layer 54 is bonded to a portion of flap back face 52 by bonding layer 59 (indicated by the area marked with “x”). Tab 48 is located on the right side of RFID label 40, and is located between flap-back face 52 and carrier layer 54. FIG. 5A shows RFID label 40 in a first position, with RFID flap 44 pressed flat against the bottom portion of RFID label 40. FIG. 5B shows RFID label 40 in a second, or operation position, wherein RFID flap 44 is physically separated from the bottom portion of RFID label 40.

As shown in FIG. 5A, RFID label 40 includes top (or printable) surface 42, RFID antenna 46, mechanical tab 48, flap back face 52, carrier layer 54, adhesive layer 56 and backing paper 58. Top surface 42 may be a printable surface that compatible with typical printers. RFID antenna is located between top surface 42 and flap back layer 52. Bonding layer 59 (indicated by area marked by ‘x’) secures the portion of flap back layer 52 located to the left of point A to carrier layer 54. To the right of point A, flap back layer 52 is not bonded to carrier layer 54, allowing flap back layer 52 to be pulled away from carrier layer 54.

Mechanical tab 48 is folded between flap back layer 52 and carrier layer 54 when RFID label 40 is in a first, non-operational state. Mechanical tab 48 is bonded to a portion of flap back layer 52, as indicated by bonding area 62 (marked with x's). In order to separate RFID flap 44 from carrier layer 54, a user pulls mechanical tab 48 in a direction indicated by arrow 61.

FIG. 5B shows RFID label 40 in the second or operational state, in which RFID flap 44 has been separated from carrier layer 54 by a user pulling mechanical tab 48 in the direction indicated by arrow 61. Backing paper 58 is removed to expose adhesive layer 56, allowing RFID label 40 to be affixed to a package or product. In one embodiment, mechanical tab 48 also includes an adhesive layer, allowing mechanical tab 48 to be secured to the package or product, thus maintaining RFID flap 44 in the operational position.

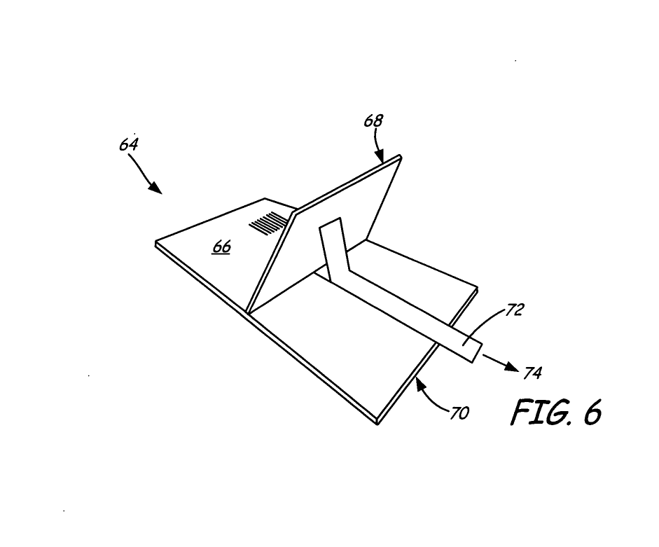

FIG. 6 is a perspective view of RFID label 64 that includes top surface 66, RFID flap 68, bottom portion 70, and mechanical portion 72. RFID antenna (not shown) is located within RFID flap 68. In contrast with FIGS. 4A-4C and 5A-5B in which the mechanical tab was separate from bottom portion 70, in this alternative embodiment mechanical tab 72 is formed from a portion of bottom portion 70. That is, bottom portion (which includes a carrier layer and adhesive layer as shown in FIGS. 5A and 5B) is cut to form a mechanical tab that can be actuated in the direction indicated by arrow 74. One end of mechanical tab 72 is once again affixed to RFID flap 68, allowing RFID flap 68 to be separated from bottom portion 70 when mechanical tab is pulled in the direction indicated by arrow 74. In this embodiment, because mechanical tab 72 is formed of bottom portion 70, it includes an adhesive layer that can be used to adhere mechanical tab 72 to a package or product, thus maintaining RFID flap 68 in the operational position.

The present invention therefore describes an RFID label that can be used in conjunction with a standard printer for printing a label or barcode onto the surface of the RFID label. An RFID flap that houses an RFID antenna can then be separated from the package or product to which the RFID label is affixed, either automatically by applying thermal energy to the RFID label, or mechanically by applying mechanical force to a tab. The separation created between the RFID antenna and the package or product to which the RFID label is affixed allows the RFID antenna to operate without interference from the package or product. This is particular useful in application in which the RFID label is affixed to metal packages or products. In addition, the description of steps employed to affix an RFID label to a package or surface does not imply an order in which the steps must be performed. For instance, in an exemplary embodiment an RFID label is affixed to the package or surface, followed by activation of the thermal-activated polymer layer or application of mechanical force if a mechanical tab is employed to separate the RFID flap from the bottom portion of the RFID label. In another exemplary embodiment, the RFID flap is separated from the bottom portion of the RFID label during printing to a top surface of the RFID label, in which heat supplied by a thermal printer is used to activate the thermally-activated polymer layer.

Although the present invention has been described with reference to preferred embodiments, workers skilled in the art will recognize that changes may be made in form and detail without departing from the spirit and scope of the invention. In particular, the present invention has been described with respect to radio frequency identification (RFID) technology, but the benefits of the present invention would apply to other technology in which the performance of a component is negatively impacted by the presence of a material or surface to which it is adhered.

1. A radio frequency identification (RFID) enabled label comprising:
a bottom portion; and
a RFID flap having a first portion, a second portion, and an RFID antenna embedded within the second portion, wherein the first portion is adhered to the bottom portion to allow the RFID flap to be placed in a first position in which the first portion and the second portion of the RFID flap are substantially adjacent to the bottom portion and a second position in which the second portion of the RFID flap is displaced from the bottom portion.

2. The RFID enabled label of claim 1, wherein the RFID flap includes:
a heat-activated polymer layer that contracts in response to heat being applied to the RFID flap to move the RFID flap from the first position to the second position.

3. The RFID enabled label of claim 2, wherein the heat-activated polymer layer is located along an entire length of the RFID flap.

4. The RFID enabled label of claim 2, wherein the heat-activated polymer layer is located adjacent to a border between the first portion of the RFID flap that is adhered to the bottom portion and the second portion of the RFID flap that is not adhered to the bottom portion.

5. The RFID enabled label of claim 2, wherein a thermal printer applies a pattern onto a top surface of the RFID enabled label and supplies thermal energy sufficient to activate the heat-activated polymer to move the RFID flap from the first position to the second position.

6. The RFID enabled label of claim 1, wherein the bottom portion includes an adhesive layer that allows the RFID enabled label to be adhered to a packaging surface.

7. The RFID enabled label of claim 1, further including:
a tab portion attached to the second portion of the RFID flap that in response to the application of mechanical force moves the RFID flap from the first position to the second position.

8. The RFID enabled label of claim 1, wherein the bottom portion includes:
a mechanical tab formed within the bottom portion and adhered at one end to the RFID flap, wherein in response to the application of mechanical force moves the RFID flap from the first position to the second position.

9. The RFID enabled label of claim 8, wherein the mechanical tab includes an adhesive layer that adheres the mechanical tab to a packaging surface following the application of mechanical force to maintain the RFID flap in the second position.

10. The RFID enabled label of claim 1, wherein the RFID flap includes a top surface for receiving images from a printer.

11. A method of using a radio frequency identification (RFID) enabled label, the method comprising:
providing the RFID enabled label to a printer in a first position, in which an RFID flap is positioned adjacent a bottom portion of the RFID enabled label;
applying the RFID enabled label to the surface by adhering the bottom portion of the RFID enabled label to the surface; and
transitioning the RFID enabled label from the first position to a second position, in which at least a portion of the RFID flap is displaced from the bottom portion.

12. The method of claim 11, wherein transitioning the RFID enabled label from the first position to the second position includes:
applying thermal energy to the RFID enabled label to activate a thermally-activated polymer layer.

13. The method of claim 12, wherein the RFID enabled label is provided to a thermal printer that applies an image to a top surface of the RFID enabled label and supplies the thermal energy for activating the thermally-activated polymer layer.

14. The method of claim 11, wherein transitioning the RFID enabled label from the first position to the second position includes:
providing mechanical force to a mechanical tab adhered to a portion of the RFID flap to move the RFID flap from the first position to the second position.

15. The method of claim 14, further including:
adhering a portion of the mechanical tab to the surface to maintain the RFID flap in the second position.

16. The method of claim 11, wherein the RFID flap includes an RFID antenna that is displaced from the surface when the RFID enabled label is in the second position.
